(19) United States
(12) Patent Application Publication
(10) Pub. No.: US 2024/0071143 A1
(43) Pub. Date: Feb. 29, 2024

(54) DIALOGUE DEVICE AND DIALOGUE METHOD

(71) Applicant: Panasonic Intellectual Property Management Co., Ltd, Osaka (JP)

(72) Inventors: Ryuga YOSHIDA, Osaka (JP); Mototaka YOSHIOKA, Osaka (JP); Kunihiro IMAMURA, Osaka (JP)

(21) Appl. No.: 18/280,174

(22) PCT Filed: Oct. 29, 2021
(86) PCT No.: PCT/JP2021/040000

§ 371 Date: Sep. 1, 2023

(30) Foreign Application Priority Data
Mar. 3, 2021 (JP) 2021-033937

(51) Int. Cl. G06V 40/60; G06V 40/16

(52) U.S. Cl. CPC G06V 40/60; G06V 40/161

(57) ABSTRACT

A dialogue device includes a controller configured to perform a control for a dialogue. The controller specifies a face image of a target person from a captured image, detects the presence or absence of a wearing object with respect to the face of the target person from the face image having been specified, determines a surrounding environment of the target person, based on predetermined reference information, and causes an output part such as a speaker or a display to output information that urges removal or wearing of the wearing object, based on the surrounding environment.

### CROSS-REFERENCE TO RELATED APPLICATIONS

This application is the U.S. National Phase under 35 U.S.C. § 371 of International Patent Application No. PCT/JP2021/040000, filed on Oct. 29, 2021, which in turn claims the benefit of Japanese Patent Application No. 2021-033937, filed on Mar. 3, 2021, the entire content of each of which is incorporated herein by reference.

### TECHNICAL FIELD

The present invention relates to a dialogue device and a dialogue method for performing a predetermined dialogue, based on a face image included in a captured image.

### BACKGROUND ART

A dialogue device that performs a predetermined dialogue, based on a face image included in a captured image is being mounted to a reception robot provided in a store, etc., a vehicle, and the like. For example, Patent Literature 1 below describes a configuration for performing a dialogue with a driver in a vehicle. In this configuration, the figure of a person sitting on a driver's seat is acquired by a 3D camera, and is outputted to an individual authentication device. The individual authentication device extracts a face image from an image captured by the 3D camera, and checks the extracted face image against a registered face image that has been registered in advance. When the matched level between the extracted face image and the registered face image is not less than a predetermined value, the individual authentication device determines that the person is the driver himself/herself, and disables the security.

On the other hand, when the matched level is less than the predetermined value, the individual authentication device extracts a portion (specific portion) in which the similarity of a feature amount is extremely low in the extracted face image, and performs a dialogue regarding this specific portion. For example, when the specific portion is a mouth, sound that suggests wearing of a mask is outputted. When the response of the person with respect to this sound is affirmative (when the response suggests wearing of a mask), the individual authentication device determines that the check result regarding the specific portion is correct, and performs identity authentication according to an authentication means (e.g., voiceprint check) other than the face image. When this authentication is appropriate, the individual authentication device determines that the person is the driver himself/herself, and performs a process of disabling the security.

### CITATION LIST

### Patent Literature

[PTL 1] Japanese Laid-Open Patent Publication No. 2010-086417

### SUMMARY OF THE INVENTION

### Problems to be Solved by the Invention

In the configuration of Patent Literature 1 above, when a target person wears a wearing object such as a mask or sunglasses, a specific portion (a portion in which the similarity is extremely low) is extracted from the face image subjected to the determination, further, a dialogue regarding this specific portion is performed, and then, a process of shifting to authentication according to another authentication means is performed. Therefore, many processes are necessary for identity authentication, and in addition, various dialogue contents need to be retained in advance for each specific portion. Even when the target person wears a wearing object, it is preferable that identity authentication is performed in a simple manner while a captured image is used as much as possible.

Meanwhile, depending on the situation around the target person, a case where urging the target person to remove a wearing object is not appropriate is also assumable. For example, when another person is present in close proximity around the target person, urging removal of a mask, which is a wearing object, can hardly be said to be appropriate. When sunlight is incident on the face of the target person, who is a driver, urging removal of sunglasses, which is a wearing object, can hardly be said to be appropriate.

In a scene other than identity authentication, conversely, a case where urging the target person to wear a predetermined wearing object is appropriate is also assumable. For example, in a closed space such as in a vehicle or in a building, when another person is present in close proximity around the target person, it can be said that urging the target person to wear a mask is appropriate.

In view of the above problem, an object of the present invention is to provide a dialogue device and a dialogue method that are capable of more appropriately guiding a target person to remove or wear a wearing object, while using a captured image.

### Solution to the Problems

A first aspect of the present invention relates to a dialogue device configured to perform a predetermined dialogue, based on a face image included in a captured image. The dialogue device according to this aspect includes a controller configured to perform a control for the dialogue. The controller specifies a face image of a target person from the captured image, detects presence or absence of a wearing object with respect to a face of the target person from the face image having been specified, determines a surrounding environment of the target person, based on predetermined reference information, and causes an output part to output information that urges removal or wearing of the wearing object, based on the surrounding environment.

In the dialogue device according to the present aspect, when the presence or absence of a wearing object in the face image of the target person has been detected, the target person is guided as to removal or wearing of the wearing object, based on a determination result regarding the surrounding environment of the target person. Therefore, while the captured image is used, the target person can be more appropriately guided as to removal or wearing of the wearing object.

A second aspect of the present invention relates to a dialogue method for automatically performing a predetermined dialogue, based on a face image included in a captured image. The dialogue method according to this aspect includes: specifying a face image of a target person from the captured image; detecting presence or absence of a wearing object with respect to a face of the target person from the face image having been specified; determining a surrounding environment of the target person, based on predetermined reference information; and outputting information that urges removal or wearing of the wearing object, based on the surrounding environment.

In the dialogue device according to the present aspect, similar to the first aspect above, when the presence or absence of a wearing object in the face image of the target person has been detected, the target person is guided as to removal or wearing of the wearing object, based on a determination result regarding the surrounding environment of the target person. Therefore, while the captured image is used, the target person can be more appropriately guided as to removal or wearing of the wearing object.

### Advantageous Effects of the Invention

As described above, according to the present invention, it is possible to provide a dialogue device and a dialogue method that are capable of more appropriately guiding a target person to remove or wear a wearing object while using a captured image.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1(a) schematically shows a use environment of a dialogue device according to Embodiment 1. FIG. 1(b) shows an example of a captured image, according to Embodiment 1.

FIG. 2 is a block diagram showing a configuration of a circuitry of the dialogue device according to Embodiment 1.

FIG. 3 is a flowchart showing an identity authentication process performed by a controller, according to Embodiment 1.

FIG. 4(a) and FIG. 4(b) are each a flowchart showing a determination process regarding a removal condition, according to Embodiment 1.

FIG. 5 shows an example in which a target face image included in a captured image is extracted by a face recognition engine, according to Embodiment 1.

FIG. 6(a) shows an example of a detection result of a case where a mask is worn, as a detection result by a wearing object recognition engine, according to Embodiment 1. FIG. 6(b) and FIG. 6(c) show examples of detection results of cases where glasses and sunglasses are worn, respectively, according to Embodiment 1.

FIG. 7 shows an example of acquiring a region of a surrounding environment, according to Embodiment 1.

FIG. 8 shows an extraction example of another person, according to Embodiment 1.

FIG. 9 schematically shows a use environment of a dialogue device according to Embodiment 2.

FIG. 10 is a flowchart showing a wearing guidance process performed by a controller, according to Embodiment 2.

FIG. 11(a) and FIG. 11(b) are each a flowchart showing a determination process regarding a wearing condition, according to Embodiment 2.

FIG. 12 is a flowchart showing a facial expression determination process performed by the controller, according to Embodiment 2.

FIG. 13 is a block diagram showing a configuration of a dialogue device according to Embodiment 3.

FIG. 14 is a flowchart showing an age confirmation process performed by a controller, according to Embodiment 3.

FIG. 15(a) and FIG. 15(b) are each a flowchart showing a determination process regarding a removal condition, according to Embodiment 3.

FIG. 16 shows a detection example of the degree of crowdedness, according to Embodiment 3.

FIG. 17(a) and FIG. 17(b) are each a flowchart showing a determination process regarding a wearing condition, according to modification of Embodiment 3.

It should be noted that the drawings are solely for description and do not limit the scope of the present invention by any degree.

### BEST MODE FOR CARRYING OUT THE INVENTION

Hereinafter, embodiments of the present invention will be described with reference to the drawings.

The embodiments below show examples of a dialogue device and a dialogue method for performing a predetermined dialogue, based on a face image included in a captured image. The dialogue device and the dialogue method perform a predetermined process through a dialogue. Here, the predetermined process can include, in addition to identity authentication based on a face image, various processes based on a face image, such as a control process based on facial expression determination regarding a target person, purchase permission for a predetermined item (e.g., alcoholic beverage, tobacco, etc.) based on age determination regarding the target person, and the like. The dialogue device and the dialogue method can be applied to various devices such as a vehicle, an age confirmation system, a reception robot, a cash dispenser, and the like.

In the following, examples of these embodiments will be shown. However, the present invention is not limited to the embodiments below in any way.

### Embodiment 1

In Embodiment 1, a configuration when the dialogue device is mounted to a cash dispenser is shown.

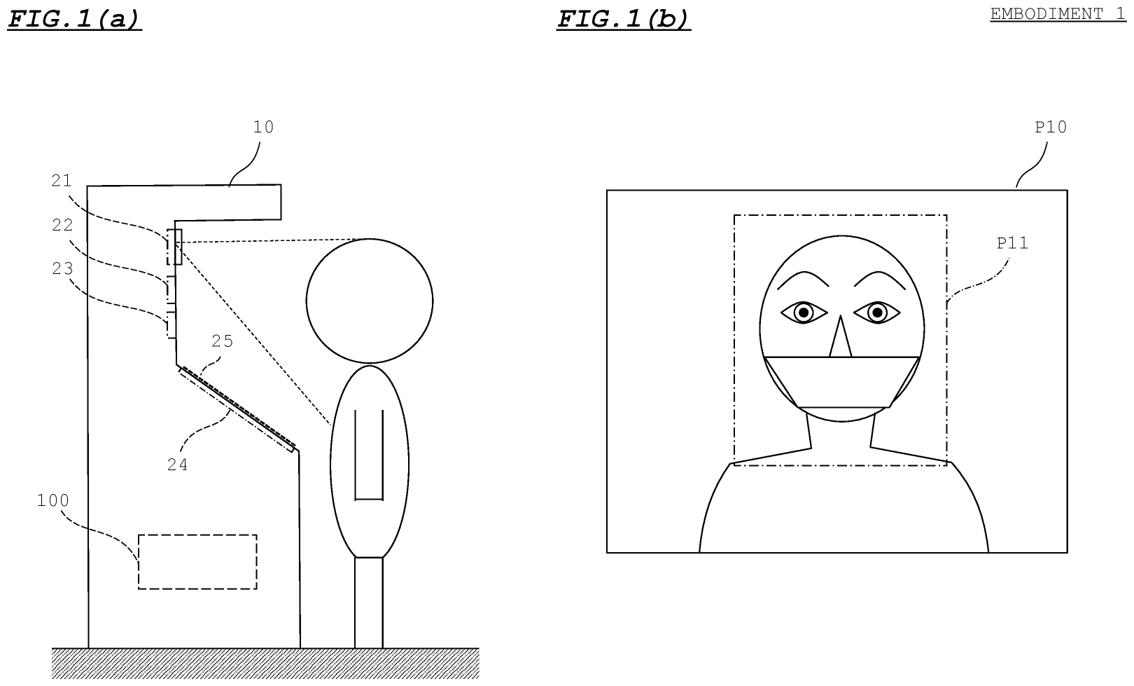

FIG. 1(a) schematically shows a use environment for a dialogue device 100.

FIG. 1(a) shows a figure including a cash dispenser 10 and an assumed use environment for an operator. FIG. 1(b) shows an example of a captured image P10 from a camera 21 mounted to the cash dispenser 10.

In Embodiment 1, a captured image from the camera 21 and sound information from a microphone 22 are used as reference information for determining the surrounding environment. However, the reference information is not limited to these, and any of these may be omitted, or another piece of information may be further added.

The dialogue device 100 is housed and installed inside the cash dispenser 10, for example. Other than this, a speaker 23 for outputting predetermined sound, a display 24 for displaying information, and a touch panel 25 for inputting information are installed in the cash dispenser 10. The display 24 and the touch panel 25 are disposed so as to be superposed with each other, to form an operation display part.

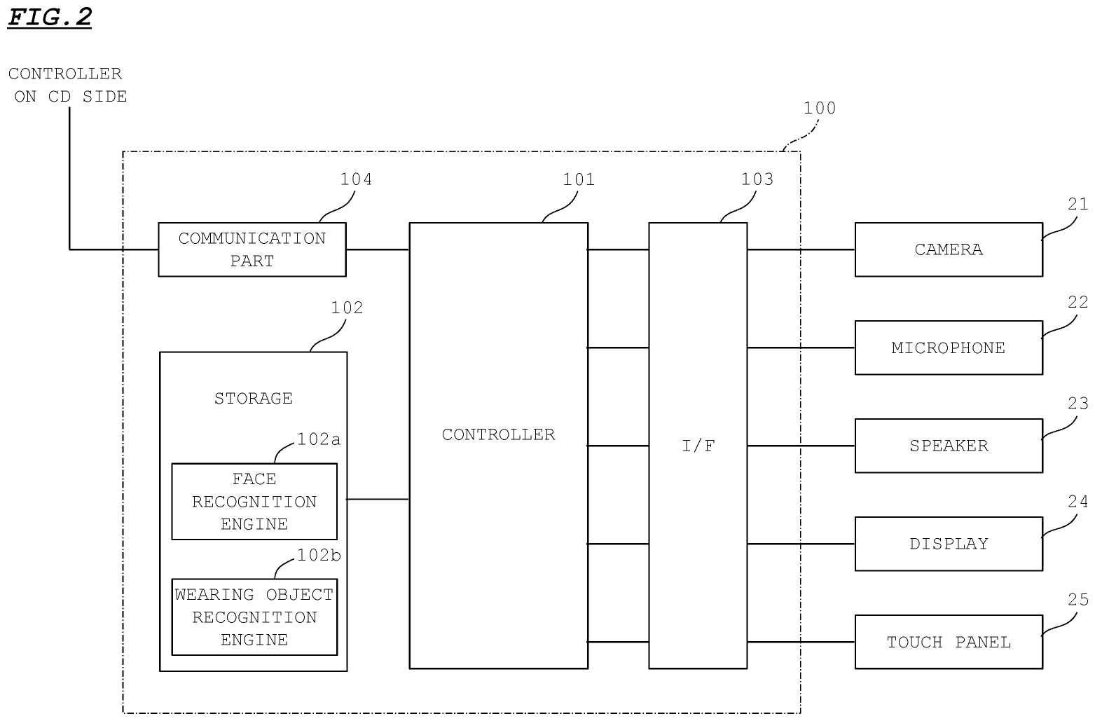

FIG. 2 is a block diagram showing a configuration of a circuitry of the dialogue device 100.

The dialogue device 100 includes a controller 101, a storage 102, an interface 103, and a communication part 104, as components of the circuitry.

The controller 101 includes an arithmetic processing circuit such as a central processing unit (CPU), and controls each component according to a program stored in the storage 102. The controller 101 may include a field programmable gate array (FPGA). The controller 101 extracts a face image in a captured image from the camera 21, by a face recognition engine 102a stored in the storage 102. Further, the controller 101 determines whether or not a wearing object such as a mask or sunglasses is included in the extracted face image, by a wearing object recognition engine 102b stored in the storage 102. When a wearing object is included in the face image, the controller 101 further specifies the kind (mask, sunglasses, or the like) of the wearing object, by the wearing object recognition engine 102b.

Further, the controller 101 includes a clock circuit 101a. The controller 101 acquires the current time, as needed, by the clock circuit 101a.

The storage 102 includes a storage medium such as a read only memory (ROM) or a random access memory (RAM), and stores a program to be executed by the controller 101. As described above, the storage 102 stores the face recognition engine 102a and the wearing object recognition engine 102b. In addition, the storage 102 stores an algorithm that performs facial expression determination, based on a face image. Further, the storage 102 stores a face image, voiceprint information, a password, and the like to be used in identity authentication described later, in association with identification information of a card of a user. Other than this, the storage 102 is used as a work region when the controller 101 executes the above program.

The interface 103 connects the camera 21, the microphone 22, and the speaker 23, and the controller 101, which have been described above, to each other. Other than this, the interface 103 connects the display 24 and the touch panel 25 to the controller 101. The communication part 104 performs, under control by the controller 101, communication with a controller on the cash dispenser side. The controller 101 performs various control processes such as identity authentication of the operator, in response to an instruction received from a communication part on the cash dispenser side via the communication part 104.

<Identity Authentication Process>

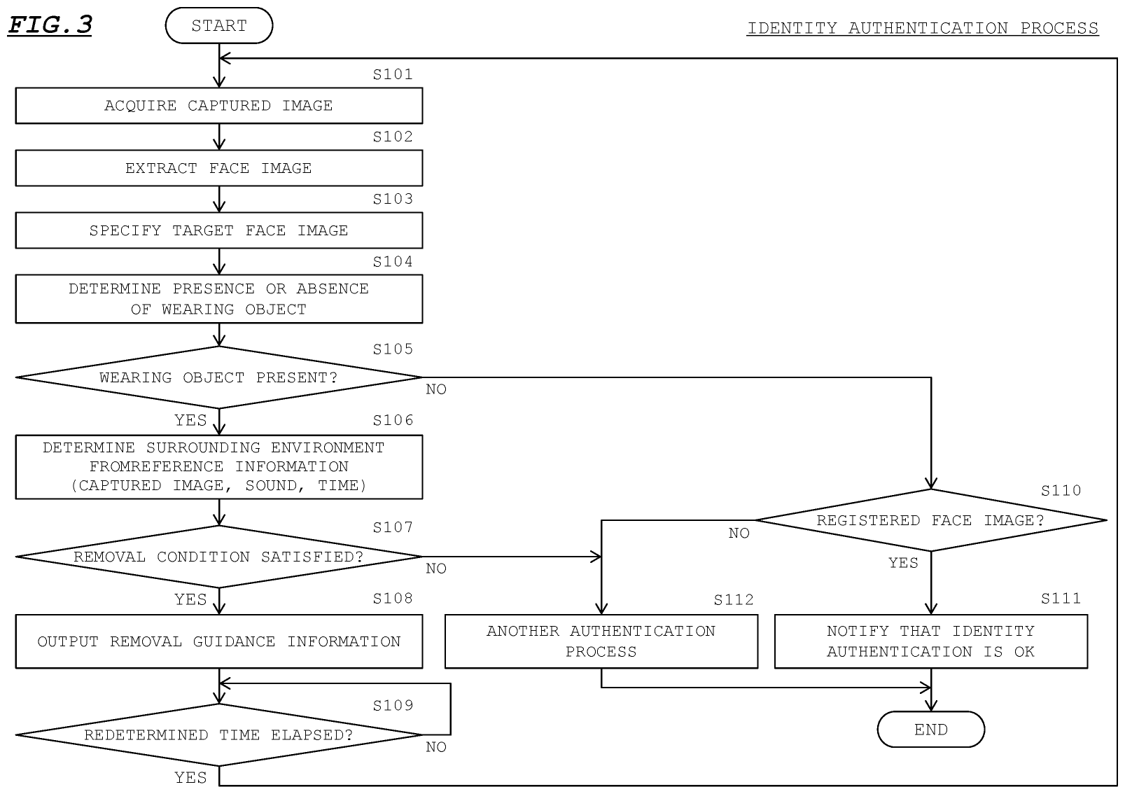

FIG. 3 is a flowchart showing an identity authentication process performed by the controller 101.

The process in FIG. 3 is started, for example, in response to a fact that the controller 101 has received an instruction (including identification information of a card received from the operator) for identity authentication, from the controller on the cash dispenser side.

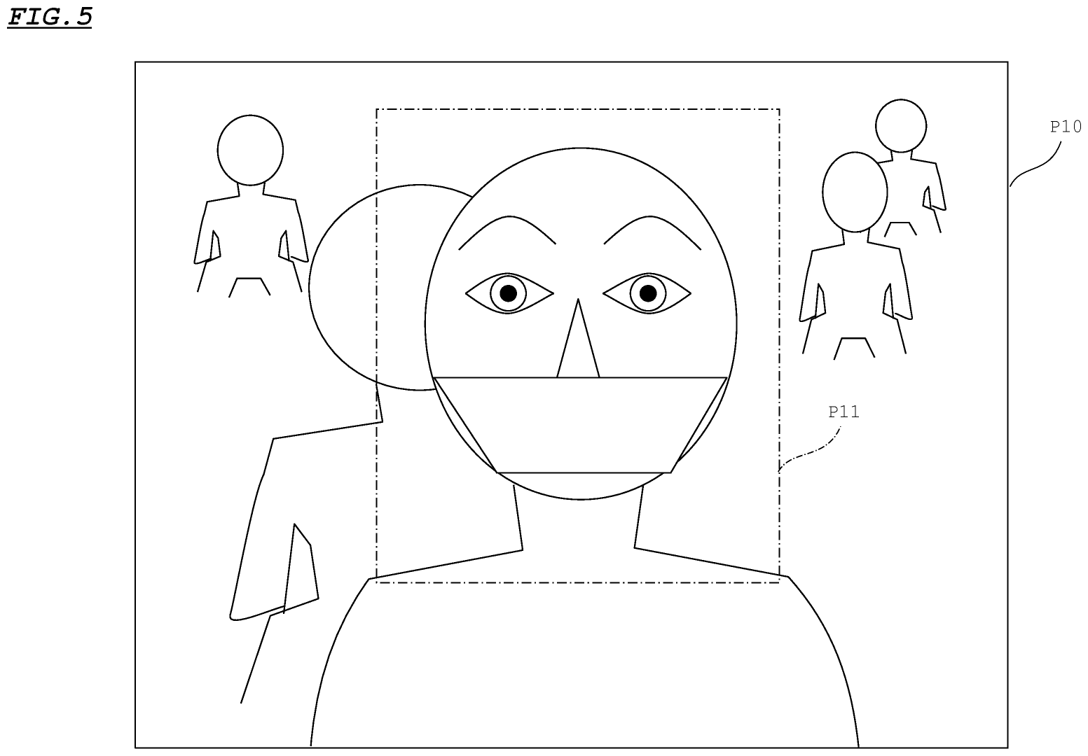

The controller 101 acquires a captured image from the camera 21 (S101), and further, extracts face images included in the captured image by the face recognition engine 102a (S102). Next, the controller 101 specifies a face image (hereinafter, referred to as a “target face image”), out of the extracted face images, of an authentication target person standing in front of the cash dispenser (S103). Here, out of the face images extracted in step S102, a face image that is in the front direction of the camera 21 and that is the largest is specified as the target face image. FIG. 5 shows an example in which a target face image P11 included in the captured image P10 is extracted by the face recognition engine 102a. Then, the controller 101 determines whether or not a wearing object is included in the target face image, by the wearing object recognition engine 102b (S104). Here, the wearing object to be recognized includes a mask, sunglasses, glasses, and the like.

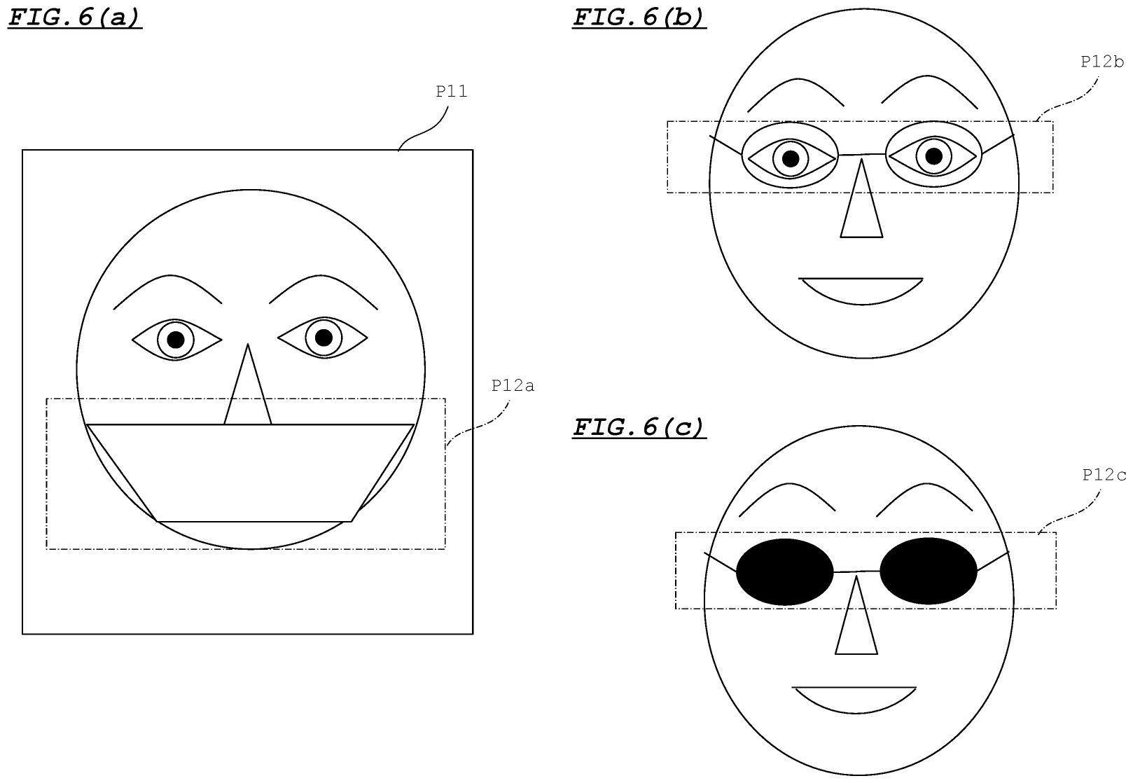

FIG. 6(a) shows an example of a detection result of a case where a mask P12a is worn, as a detection result by the wearing object recognition engine 102b. FIGS. 6(b), 6(c) show examples of detection results of cases where glasses P12b and sunglasses P12c are worn, respectively.

When no wearing object is included in the target face image (S105: NO), the controller 101 checks the target face image against the registered face image of the operator registered in advance in the storage 102, and determines whether or not the matching rate therebetween exceeds a predetermined threshold (e.g., 70%) (S110). At this time, when a plurality of registered face images are stored in the storage 102, the controller 101 obtains a matching rate between each registered face image and the target face image, and determines whether or not the highest matching rate among these exceeds the threshold (S110).

When the registered face image is a face image in a state of, for example, wearing a predetermined wearing object such as glasses, the kind of the wearing object included in the registered face image is stored in advance in association with the registered face image, in the storage 102. When the wearing object determined in step S104 is only the wearing object associated with the registered face image, the determination in step S105 is NO.

When the matching rate described above exceeds the threshold (S110: YES), the controller 101 determines that the operator is the person himself/herself, and transmits a notification indicating that the identity authentication has been appropriately performed, to the controller on the cash dispenser side (S111). Accordingly, the controller on the cash dispenser side executes a transaction according to the operation.

On the other hand, when the matching rate described above does not exceed the threshold (S110: NO), the controller 101 determines that the identity authentication based on the face image has failed and executes an identity authentication process according to another approach such as voiceprint or a password (S112). When the identity authentication has been successful with this authentication process, the controller 101 transmits a notification indicating that the identity authentication has been appropriately performed, to the controller on the cash dispenser side, as in step S111. On the other hand, when the identity authentication has not been appropriately performed even with this authentication process, the controller 101 transmits a notification indicating that the identity authentication has been inappropriate, to the controller on the cash dispenser side. Accordingly, the controller on the cash dispenser side performs a predetermined announcement, and stops the transaction.

In step S105, when having determined that a wearing object is included in the target face image (S105: YES), the controller 101 determines the surrounding environment of the target person from the reference information (S106).

Specifically, using a captured image from the camera 21 and sound from the microphone 22 as the reference information, the controller 101 determines whether or not another person other than the operator is present therearound. For example, when having extracted a face other than that of the target person from the captured image, the controller 101 determines that another person other than the target person is present therearound.

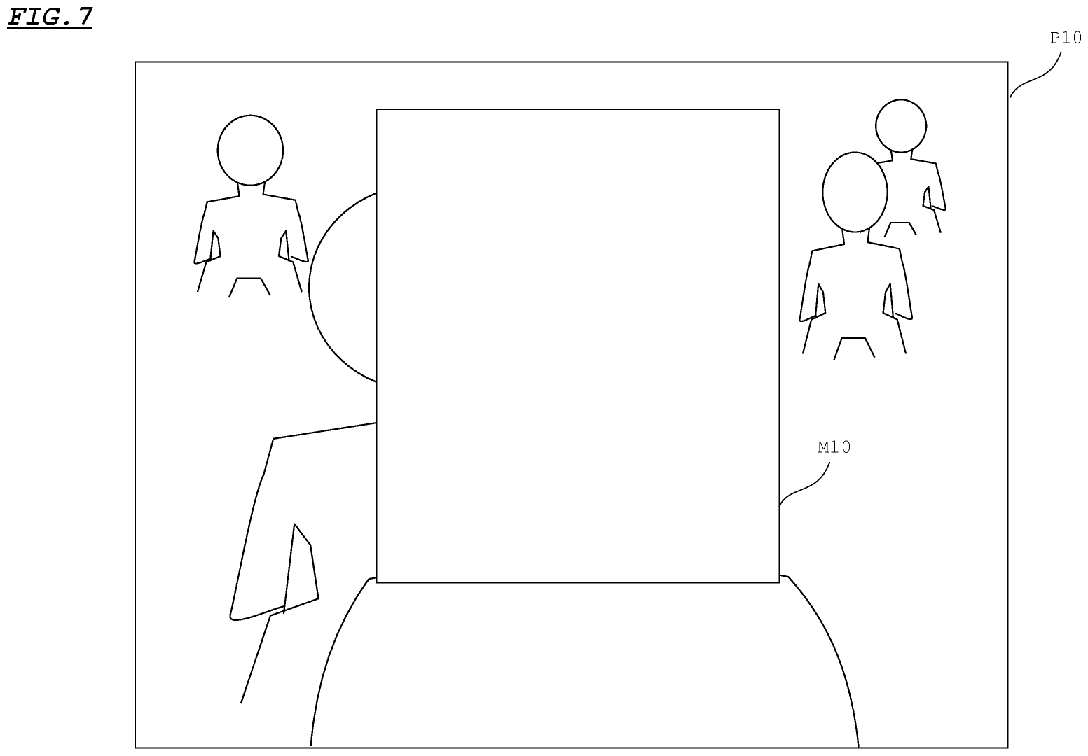

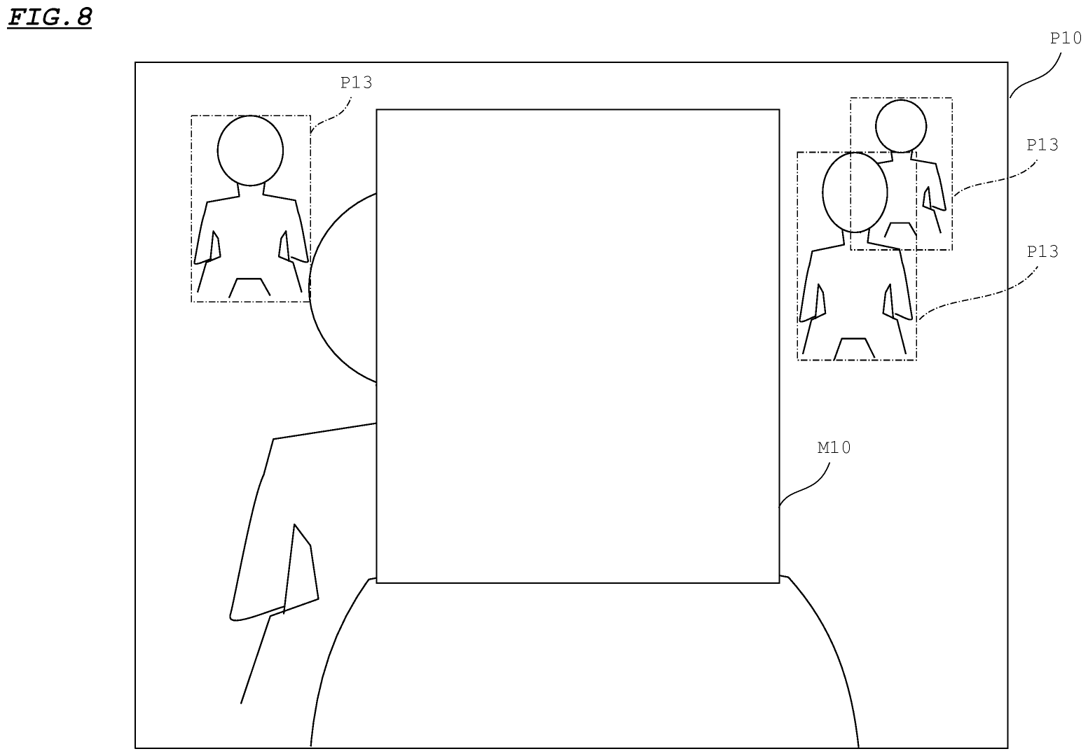

FIG. 7 shows an example of acquiring a region of a surrounding environment, and FIG. 8 shows an extraction example of another person. As shown in FIG. 7, the controller 101 sets a region excluding a mask region M10 including the range of the face of the target person from the captured image P10, as an acquired region of the surrounding environment. Then, as shown in FIG. 8, the controller 101 specifies the faces of other persons P13 present in the acquired region of the surrounding environment, by using the face recognition engine 102a.

Even when not having extracted any face other than that of the target person from the captured image, but having detected buzzing or the like therearound, based on the sound from the microphone 22, the controller 101 determines that another person other than the target person is present therearound.

In addition, using the current time from the clock circuit 101a as the reference information, the controller 101 determines whether or not the current time is included in a time period in which sunlight is incident on the face of the operator.

Then, after having determined the surrounding environment, the controller 101 determines whether or not this surrounding environment satisfies a removal condition for the wearing object (S107).

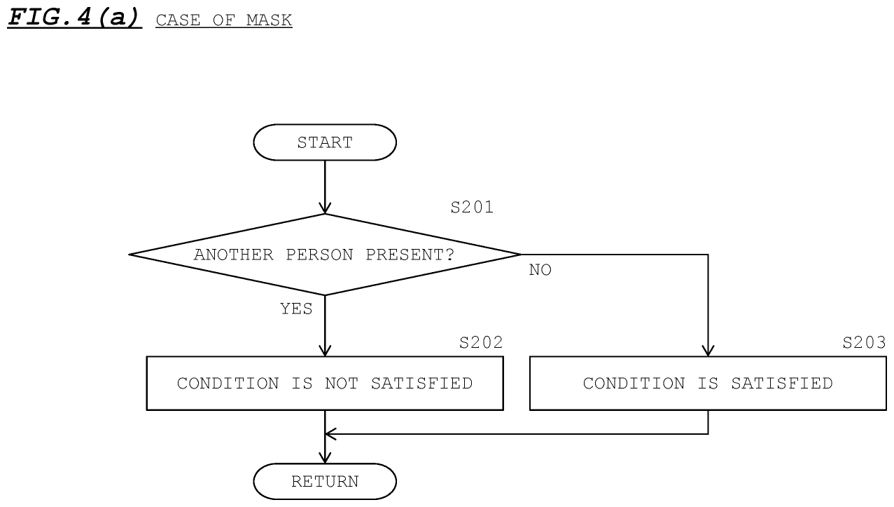

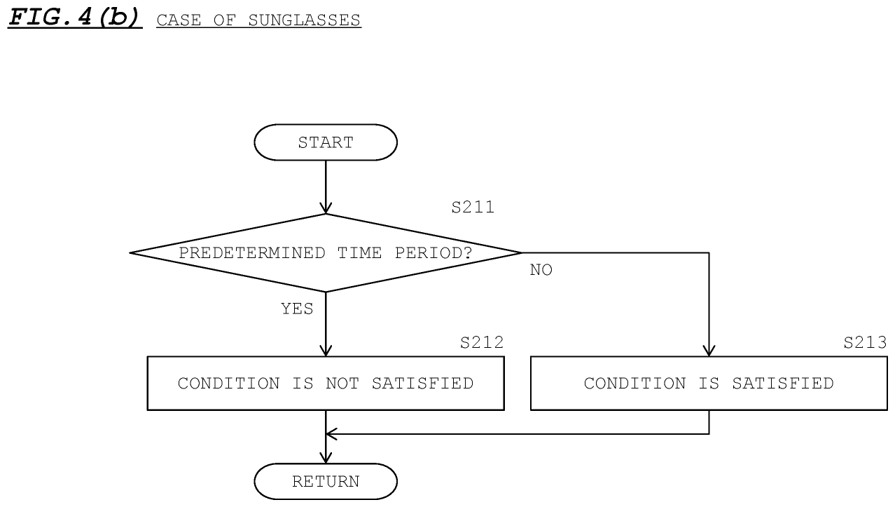

FIGS. 4(a), 4(b) are each a flowchart showing a determination process regarding a removal condition.

In the present embodiment, the removal condition is set only for a mask and sunglasses. For a wearing object other than a mask and sunglasses, the controller 101 uniformly determines that the removal condition is satisfied. When a wearing object is included in the registered face image as described above, the wearing object associated with the registered face image is not subjected to the determination regarding the removal condition.

With reference to FIG. 4(a), when the wearing object subjected to the determination is a mask, the controller 101 determines whether or not the determination result regarding the surrounding environment in step S104 includes a fact that another person is present therearound (S201). When another person is present therearound (S201: YES), the controller 101 determines that the removal condition is not satisfied (S202). On the other hand, when another person is not present therearound (S201: NO), the controller 101 determines that the removal condition is satisfied (S203).

With reference to FIG. 4(b), when the wearing object subjected to the determination is sunglasses, the controller 101 determines whether or not the determination result regarding the surrounding environment in step S104 includes a determination result that the current time is included in a time period in which sunlight is incident on the face of the operator (S211: YES). When the current time is included in the time period, the controller 101 determines that the removal condition is not satisfied (S212). On the other hand, when the current time is not included in the time period (S211: NO), the controller 101 determines that the removal condition is satisfied (S213).

The determination step regarding the removal condition is not limited to the steps shown in FIGS. 4 (a), 4(b). For example, when the wearing object is sunglasses, the time period to be compared with the current time may be changed in accordance with the season, or the day, month, and year, and in addition, whether or not the orientation of the cash dispenser 10 is included in the range of the azimuth in which sunlight is incident on the face of the operator may be further determined. In this case, the controller 101 may perform this determination, based on the azimuth of the cash dispenser 10 set in advance by an administrator. Even when the current time is included in the time period, if the orientation of the cash dispenser 10 is not included in the range of the azimuth in which sunlight is incident on the face of the operator, the controller 101 can determine that the removal condition is satisfied.

When it is preferable to restrict removal of a predetermined wearing object other than a mask and sunglasses in terms of a relationship with a predetermined surrounding environment, a removal condition based on the situation of the surrounding environment may be set also for the wearing object.

With reference back to FIG. 3, when the removal condition has been satisfied with respect to all the wearing objects subjected to the determination (S107: YES), the controller 101 causes removal guidance information for guiding removal of the wearing object to be outputted.

Here, the removal guidance information is outputted as sound from the speaker 23 in FIG. 2. For example, when the wearing object to be removed is a mask and sunglasses, the controller 101 causes the speaker 23 to output sound that “removal of the mask and the sunglasses for identity authentication is requested”. The removal guidance information may be displayed as a message on the display 24. In this case, for example, the message is displayed on the display 24, together with a chime sound. Alternatively, the display 24 may be flash-controlled. The message may be outputted from both of the speaker 23 and the display 24.

After the removal guidance information has been outputted, the controller 101 waits for a predetermined time to elapse for the target person to remove the wearing object (S109). When the predetermined time has elapsed (S109: YES), the controller 101 returns the process to step S101 and executes processes similar to the above. When the target person has removed the designated wearing object in response to the output of the removal guidance information, the determination in step S105 performed again becomes NO. Accordingly, similar to the above, the processes in step S110 and thereafter are executed.

On the other hand, when the determination in step S107 is NO, that is, the removal condition is not satisfied with respect to at least one of the wearing objects, the controller 101 determines that identity authentication based on the target face image is not possible, and executes an authentication process according to another authentication means such as voiceprint information or a password (S112). Through the processes above, when the authentication process according to the target face image or another authentication means is completed, the controller 101 ends the process in FIG. 3.

### Effects of Embodiment 1

As shown in FIG. 3, when the presence or absence of a wearing object in the face image of the target person has been detected (S105), based on the determination result regarding surrounding environment of the target person (S106), removal of the wearing object is guided (S108). Thus, while the captured image is used, removal of the wearing object can be more appropriately guided.

As described above, the reference information includes a captured image (S106), and in the process in FIG. 4(a), the controller 101 determines, as the surrounding environment, the situation of another person other than the target person included in the captured image (S201), and urges removal of the wearing object (mask). Accordingly, while the possibility of contracting a disease due to non-wearing of a mask is suppressed, removal of a mask can be appropriately guided.

As described above, the reference information includes sound around the target person (S106), and, in the process in FIG. 4 (a), the controller 101 determines, as the surrounding environment, the situation of a person other than the target person from the sound, and urges removal of the wearing object (mask). Accordingly, a surrounding environment (the presence or absence of another person) that cannot be detected in the captured image can be detected based on the sound. Therefore, removal of the wearing object (mask) based on the surrounding environment can be more appropriately guided.

As shown in FIG. 4(a), the wearing object subjected to removal guidance includes a mask. Therefore, in accordance with the presence or absence of another person, removal of the mask can be guided. Therefore, while the possibility of contracting a disease due to non-wearing of a mask is suppressed, the process of identity authentication can be appropriately performed.

The wearing object subjected to the wearing/removal guidance includes sunglasses. The reference information includes the current time (S106), and in the process in FIG. 4(b), the controller 101 determines, based on the current time, whether or not sunlight is in a situation of being able to be incident on the face of the operator, as the surrounding environment, and urges removal of the sunglasses. Accordingly, while comfort due to reduction of glare is taken into consideration, removal of sunglasses can be appropriately guided.

### Embodiment 2

In Embodiment 2, a configuration when the dialogue device is mounted to a vehicle is shown. The configuration of the dialogue device 100 is similar to the configuration in FIG. 2 shown in Embodiment 1 above. In Embodiment 2, communication is performed between the controller 101 and a controller on the vehicle side via the communication part 104. For convenience, in Embodiment 2, the same numbers as those of the camera 21, the microphone 22, the speaker 23, the display 24, and the touch panel 25 are used.

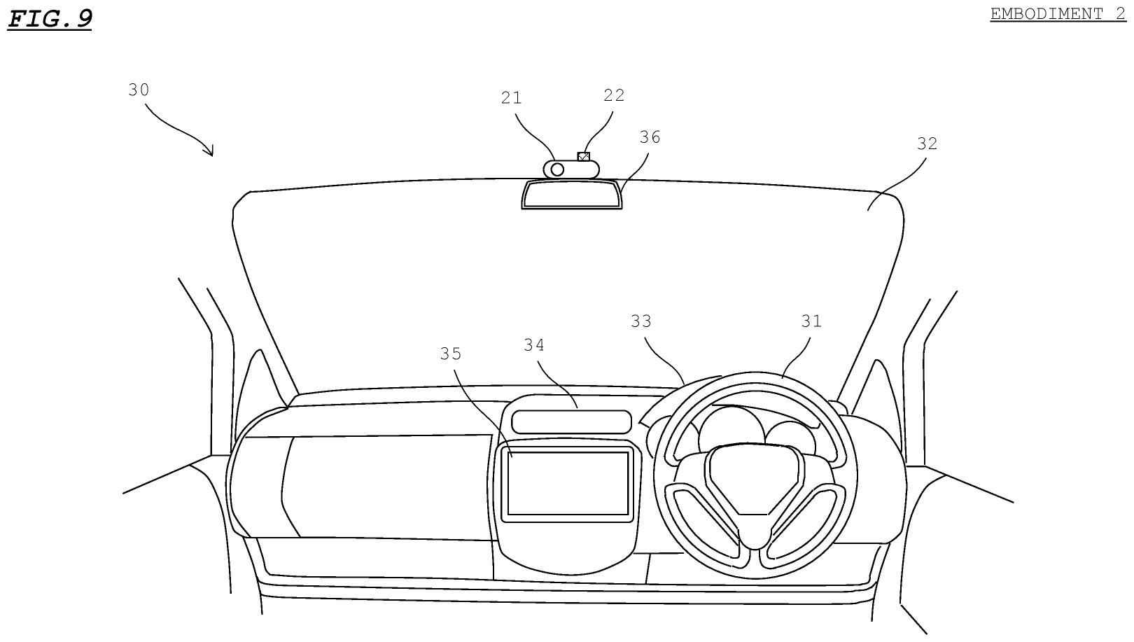

FIG. 9 schematically shows a use environment of the dialogue device 100. FIG. 9 shows a figure in which the traveling direction is viewed forward from the inside of a passenger car 30 (vehicle).

In Embodiment 2, as reference information for determining the surrounding environment, a captured image from the camera 21, sound information from the microphone 22, and the current time from the clock circuit 101a are used. However, the reference information is not limited thereto, and any of these may be omitted, or another piece of information may be further added.

As shown in FIG. 9, the passenger car 30 includes a steering wheel 31, a windshield 32, a dashboard 33, an operation display part 34, a conditioned-air blowout port 35, and a rearview mirror 36. The operation display part 34 is a user interface of a car navigation system. The operation display part 34 is composed of the display 24 and the touch panel 25. The camera 21 and the microphone 22 are installed above the rearview mirror 36. The camera 21 has an angle that can include the driver's seat and all the other passenger seats. The microphone 22 collects and acquires sound in the vehicle.

<Identity Authentication Process>

The identity authentication process is performed according to a process similar to that in FIG. 3. The identity authentication process is started in response to, for example, a fact that an ignition switch of the vehicle has been operated to be on, or a fact that the controller 101 has received from the controller on the vehicle side a notification indicating that a button for identity authentication disposed in the vehicle has been operated. In response to these operations, the camera 21, the microphone 22, the speaker 23, the display 24, and the touch panel 25 start to operate.

In this process, in a case where the target person sitting on the driver's seat wears a mask or sunglasses, when a removal condition is satisfied, information that urges removal of these wearing objects is outputted. On the other hand, when the removal condition is not satisfied, another authentication process other than face authentication is performed. In this case, voiceprint authentication using the microphone 22 or password authentication using the operation display part 34 is performed.

The determination process regarding the removal condition is similar to those in FIGS. 4(a), 4(b). In the case of FIG. 4(a), whether or not a passenger as another person is present is determined. In the case of FIG. 4(b), whether or not the current time is included in a time period in which sunlight is incident on the face of the driver is determined.

Similar to Embodiment 1 above, when the wearing object is sunglasses, the time period to be compared with the current time may be changed in accordance with the season, or the day, month, and year, and in addition, whether or not the orientation of the passenger car 30 is included in the range of the azimuth in which sunlight is incident may be further determined. In this case, the controller 101 may receive the orientation of the vehicle acquired by a global positioning system (GPS), from the controller on the vehicle side.

The result of the identity authentication is transmitted from the controller 101 to the controller on the vehicle side. When the identity authentication has been successful, the controller on the vehicle side disables the security, activates the engine, and sets the vehicle to a state where normal driving operation can be executed. On the other hand, when the identity authentication has failed, the controller on the vehicle side, while maintaining the security, performs processes of outputting an alarm, transmitting an abnormality notification to a mail address registered in advance, and the like.

In Embodiment 2, in addition to the identity authentication process, a wearing guidance process for urging the driver to wear a predetermined wearing object and a facial expression determination process for performing a predetermined control, based on a facial expression of the driver are performed. In the following, these processes will be described.

<Wearing Guidance Process>

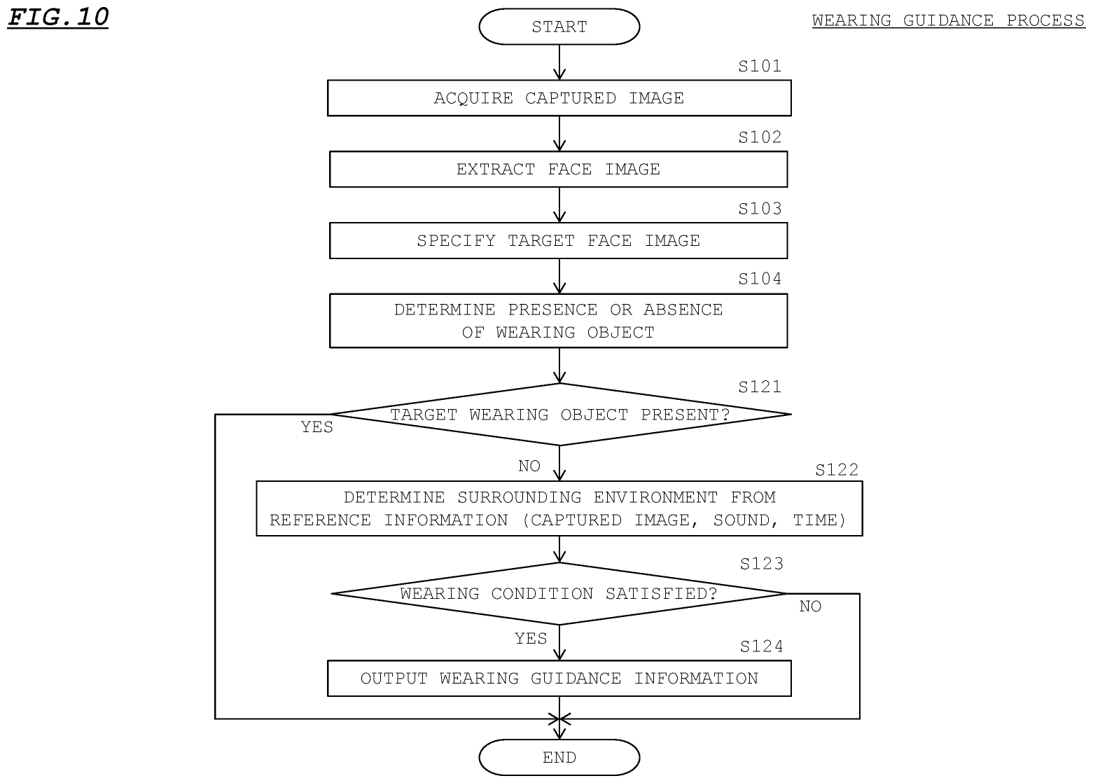

FIG. 10 is a flowchart showing a wearing guidance process performed by the controller 101.

The process in FIG. 10 is executed at a predetermined timing in a time after the engine is activated until the engine is stopped. For convenience, in the flowchart in FIG. 10, steps similar to those in the flowchart in FIG. 3 are denoted by the same step numbers as those in FIG. 3.

Through the processes of step S101 to step S104, the controller 101 specifies a target face image (the face image of the driver sitting on the driver's seat) from a captured image, and further, determines whether or not the target face image includes a wearing object. Then, the controller 101 determines whether or not the target face image includes a wearing object (hereinafter, referred to as “target wearing object”) that can be assumed to be preferable to urge the driver to wear in accordance with the surrounding environment (S121). Here, a mask and sunglasses are set as the target wearing object. However, the target wearing object is not limited thereto.

When the target face image includes all the target wearing objects (S121: YES), the controller 101 ends the process. On the other hand, when the target face image does not include at least one of the target wearing objects (S121: NO), the controller 101 determines the surrounding environment of the target person from the reference information (S122).

The process in step S122 is similar to the process in step S106 in FIG. 3. That is, using a captured image from the camera 21 and sound from the microphone 22 as the reference information, the controller 101 determines whether or not another person (passenger) other than the target person sitting on the driver's seat is present in the vehicle. In addition, using the current time from the clock circuit 101a as the reference information, the controller 101 determines whether or not the current time is included in a time period in which sunlight is incident on the face of the driver sitting on the driver's seat.

Then, after determining the surrounding environment, the controller 101 determines whether or not this surrounding environment satisfies a wearing condition for the wearing object (S123).

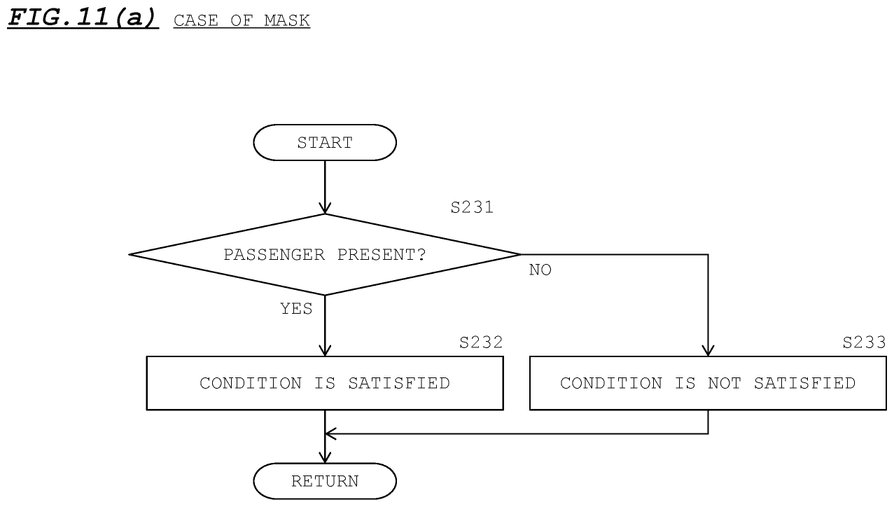

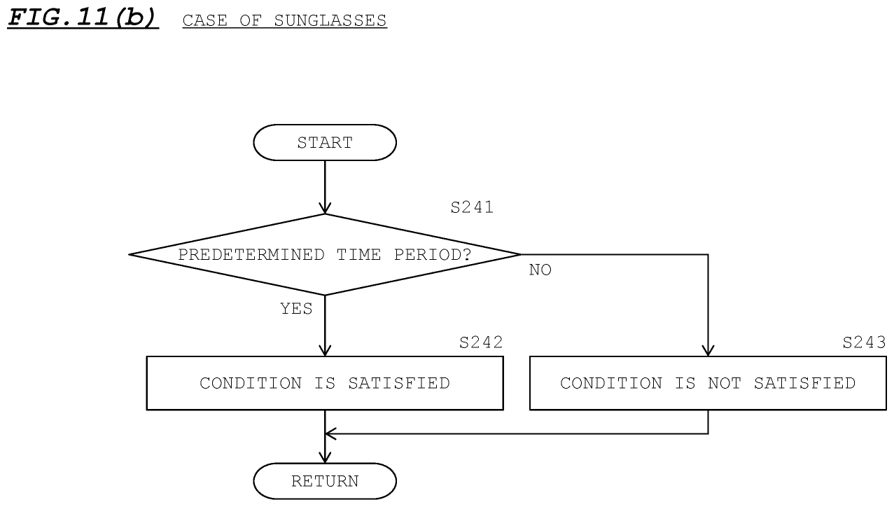

FIGS. 11(a), 11(b) are each a flowchart showing a determination process regarding a wearing condition.

With reference to FIG. 11(a), when the target wearing object is a mask, the controller 101 determines whether or not the determination result regarding the surrounding environment in step S104 includes a fact that a passenger is present in the vehicle (S231). When a passenger is present in the vehicle (S231: YES), the controller 101 determines that the wearing condition is satisfied (S232). On the other hand, when no passenger is present in the vehicle (S231: NO), the controller 101 determines that the wearing condition is not satisfied (S233).

With reference to FIG. 11(b), when the target wearing object is sunglasses, the controller 101 determines whether or not the determination result regarding the surrounding environment in step S104 includes a determination result that the current time is included in a time period in which sunlight is incident on the face of the driver sitting on the driver's seat (S241: YES). When the current time is included in the time period, the controller 101 determines that the wearing condition is satisfied (S242). On the other hand, when the current time is not included in the time period (S241: NO), the controller 101 determines that the wearing condition is not satisfied (S243).

Similar to the cases of FIGS. 4(a), 4(b), the determination step regarding the wearing condition is not limited to the steps shown in FIGS. 11(a), 11(b). For example, when the wearing object is sunglasses, the time period to be compared with the current time may be changed in accordance with the season, or the day, month, and year, and whether or not the orientation of the vehicle is included in the range of the azimuth in which sunlight is incident may be further determined. Further, when it is preferable to perform guidance of wearing a predetermined wearing object other than a mask and sunglasses in terms of a relationship with a predetermined surrounding environment, a wearing condition based on the situation of the surrounding environment may be set also for the wearing object.

With reference back to FIG. 10, when the wearing condition with respect to any target wearing object has been satisfied (S123: YES), the controller 101 causes wearing guidance information for guiding wearing of the wearing object, to be outputted.

Here, the wearing guidance information is outputted as sound from the speaker 23 in FIG. 2. For example, when the target wearing object is a mask, the controller 101 causes the speaker 23 to output sound that “wearing a mask is recommended”. When the target wearing object is sunglasses, the controller 101 causes the speaker 23 to output sound that “wearing sunglasses is recommended since it is a time period in which sunlight is incident on the face”. The wearing guidance information may be displayed as a message on the display 24. In this case, for example, the message is displayed on the display 24, together with a chime sound. The message may be outputted from both of the speaker 23 and the display 24. Then, after the wearing guidance information has been outputted, the controller 101 ends the process in FIG. 10.

<Facial Expression Determination Process>

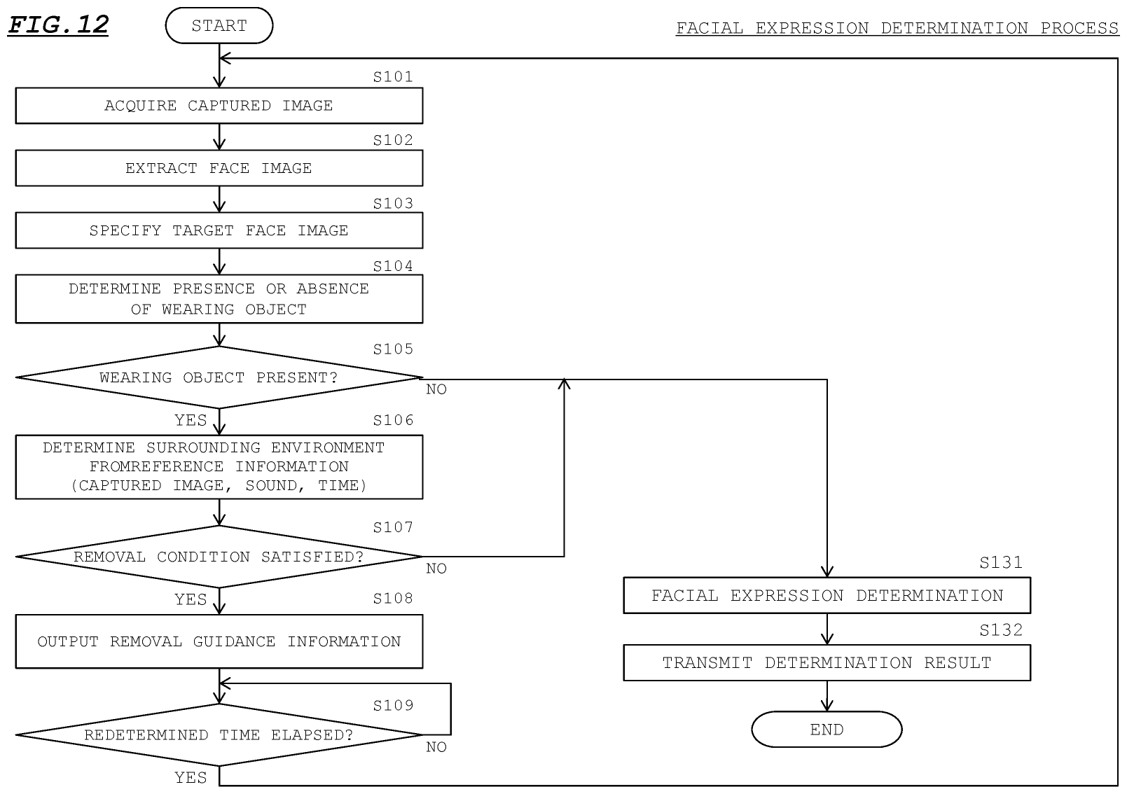

FIG. 12 is a flowchart showing a facial expression determination process performed by the controller 101.

The process in FIG. 12 is executed at a predetermined timing in a time after the engine is activated until the engine is stopped. For convenience, in the flowchart in FIG. 12, steps similar to those in the flowchart in FIG. 3 are denoted by the same step numbers as those in FIG. 3.

Through the processes in step S101 to step S109, the controller 101 guides removal of the wearing object from the face of the driver. Here, the determination in step S105 may be limited only to wearing objects, such as a mask, sunglasses, and the like, that may hinder the determination of the facial expression of the face.

Through this guidance, when the target face image of the driver no longer includes the wearing object (S105: NO), the controller 101 determines the facial expression in the target face image by a facial expression determination algorithm (S131). For example, from the target face image, the controller 101 determines a facial expression of being comfortable, sleepy, tired, hot, cold, or the like. Then, the controller 101 transmits the determination result regarding the facial expression to the controller on the vehicle side (S132).

The controller on the vehicle side performs a control according to the received determination result. For example, when the determination result is “sleepy”, the controller on the vehicle side lowers the set temperature of an air conditioner by a predetermined temperature in order to suppress the sleepiness. When the determination result is “tired”, the controller on the vehicle side causes the speaker 23 to output a message that urges rest. Then, the controller 101 ends the process in FIG. 12.

### Effects of Embodiment 2

According to Embodiment 2, effects similar to those in Embodiment 1 can be exhibited.

In addition, in Embodiment 2, through the process in FIG. 10, wearing of a wearing object (mask, sunglasses) is guided based on the surrounding environment. Therefore, safety for the passenger and the driver can be enhanced.

Through the process in FIG. 12, while removal of the wearing object (mask, sunglasses) is urged based on the surrounding environment, a control based on the facial expression determination is performed. Accordingly, while the surrounding environment including the inside of the vehicle is taken into consideration, safety of the driving can be enhanced.

The process in FIG. 10 may also be executed in Embodiment 1 above during a transaction process after the identity authentication has been ended.

### Embodiment 3

In Embodiment 2 above, the dialogue device 100 is mounted to the passenger car 30 (vehicle). In contrast to this, in Embodiment 3, a dialogue device is used in a purchase permission system that permits purchase of an alcoholic beverage and tobacco. The purchase permission system is installed in a payment counter or the like of a store.

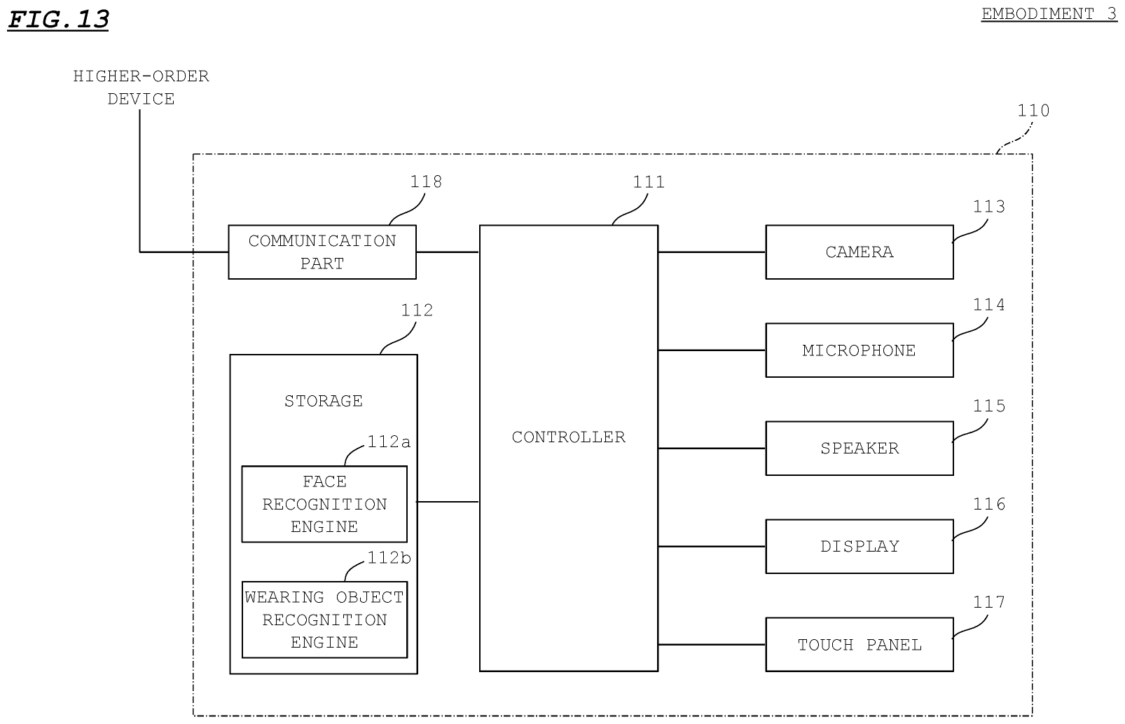

FIG. 13 is a block diagram showing a configuration of a dialogue device 110 according to Embodiment 3.

In Embodiment 3, as reference information for determining the surrounding environment, a captured image from a camera 113 and sound acquired by a microphone 114 are used. However, the reference information is not limited thereto, and any of these may be omitted, or another piece of information may be further added. For example, a captured image from a monitoring camera for monitoring the inside of the store may further be used as the reference information for determining the surrounding environment.

As shown in FIG. 13, the dialogue device 110 includes a controller 111, a storage 112, the camera 113, the microphone 114, a speaker 115, a display 116, a touch panel 117, and a communication part 118.

The controller 111 includes an arithmetic processing circuit such as a CPU, and controls each component according to a program stored in the storage 112. The controller 111 may include an FPGA. The controller 111 extracts a face image in a captured image from the camera 113, by a face recognition engine 112a stored in the storage 112. Further, the controller 111 determines whether or not a wearing object such as a mask or sunglasses is included in the extracted face image, by a wearing object recognition engine 112b stored in the storage 112. When a wearing object is included in the face image, the controller 111 further specifies the kind (mask, sunglasses, or the like) of the wearing object, by the wearing object recognition engine 112b.

The storage 112 includes a storage medium such as a ROM or a RAM, and stores a program to be executed by the controller 111. As described above, the storage 112 stores the face recognition engine 112a and the wearing object recognition engine 112b. In addition, the storage 112 stores an algorithm that performs age determination, based on a face image. Other than this, the storage 112 is used as a work region when the controller 111 executes the above program.

The camera 113 performs imaging at an angle that can include a commodity purchaser and a region therearound. The microphone 114 collects and acquires sound of the commodity purchaser and in a region therearound. The display 116 and the touch panel 117 form an operation display part disposed on the front panel of the dialogue device 110. The communication part 118 performs, under control by the controller 111, communication with a higher-order device (e.g., settlement machine) of a purchase permission system. The controller 111 performs a process for age confirmation of the commodity purchaser in response to an instruction received from a communication part of the higher-order device via the communication part 118.

<Age Confirmation Process>

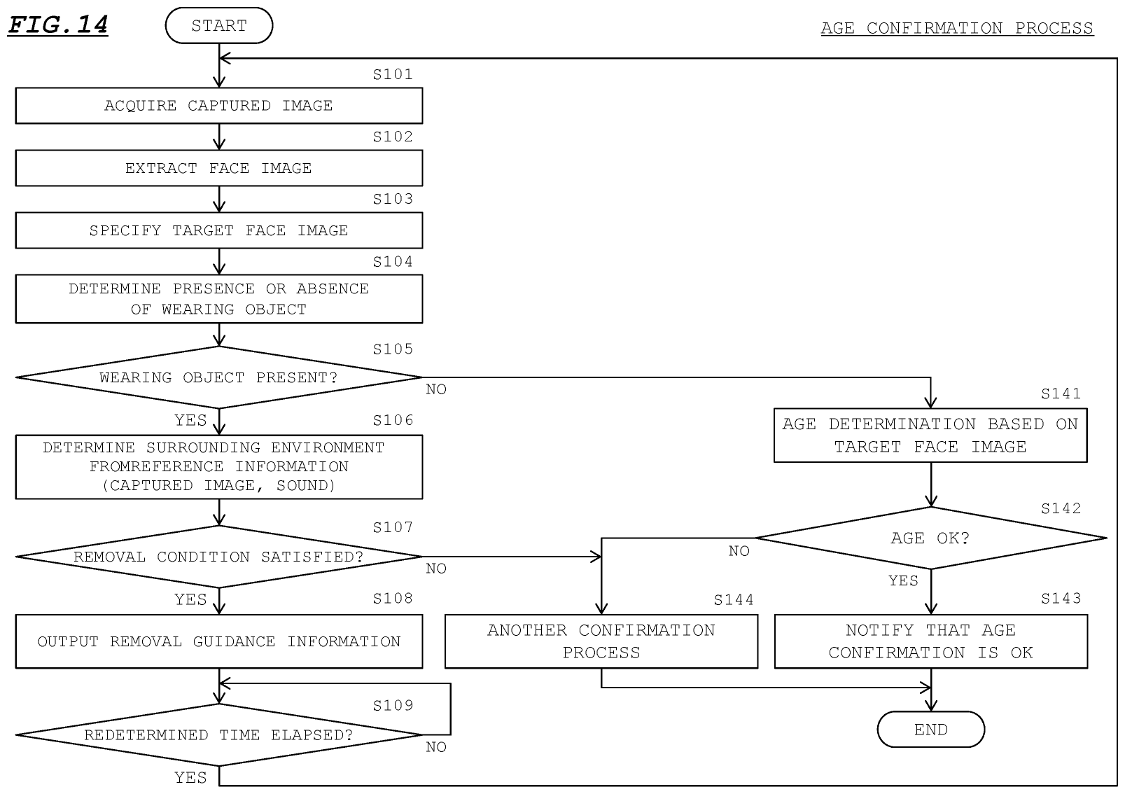

FIG. 14 is a flowchart showing an age confirmation process performed by the controller 111.

The process in FIG. 14 is executed in response to a fact that the controller 111 has received an age confirmation instruction from the higher-order device. For convenience, in the flowchart in FIG. 14, steps similar to those in the flowchart in FIG. 3 are denoted by the same step numbers as those in FIG. 3.

Through the processes in step S101 to step S105, the controller 111 determines whether or not a wearing object is worn on the face of a commodity purchaser. In step S103, out of extracted face images, the largest face image is specified as the face image (target face image) of the commodity purchaser. The determination in step S105 may be limited to wearing objects, such as a mask, sunglasses, and the like, that may hinder the age determination.

When the determination in step S105 is NO, the controller 111 determines the age of the commodity purchaser, based on the target face image, by an age determination algorithm (S141). Then, the controller 111 determines whether or not the determined age exceeds a predetermined threshold (S142). Here, in order to assuredly prevent a minor from being permitted to purchase an alcoholic beverage and tobacco, the threshold set in step S142 is set to an age (e.g., a predetermined age of 30 years old or more) higher than a statutory age.

When the determination in step S142 is YES, the controller 111 transmits, to the higher-order device, a notification indicating that the age confirmation has been appropriate (S143). Accordingly, in the higher-order device, a purchase procedure of the commodity is advanced. On the other hand, when the determination in step S142 is NO, the controller 111 executes another age confirmation process (S144). For example, the controller 111 causes the display 116 to display a screen for receiving confirmation that the age of the commodity purchaser is an age at which purchase of the commodity is allowed. On this screen, when the commodity purchaser has inputted a response that the commodity purchaser is at an age at which purchase of the commodity is allowed, the controller 111 transmits, to the higher-order device, a notification indicating that the age confirmation has been appropriate.

When the determination in step S105 is YES, the controller 111 guides removal from the face of the commodity purchaser of the wearing object that hinders the age determination, by the processes in step S106 and thereafter.

First, in step S106, the controller 111 determines the situation (surrounding environment) around the commodity purchaser, by using a captured image from the camera 113 and sound acquired by the microphone 114. Here, whether or not another person is present around the commodity purchaser is determined, and in addition, the degree of crowdedness of other persons is determined. As the degree of crowdedness of other persons, the number of other persons included in a predetermined distance range from the commodity purchaser and the distance between the commodity purchaser and each of the other persons are determined. As described above, in these determinations regarding the surrounding environment, a captured image from a monitoring camera may further be used in addition to the captured image from the camera 113, or a captured image from a monitoring camera may be used instead of the captured image from the camera 113.

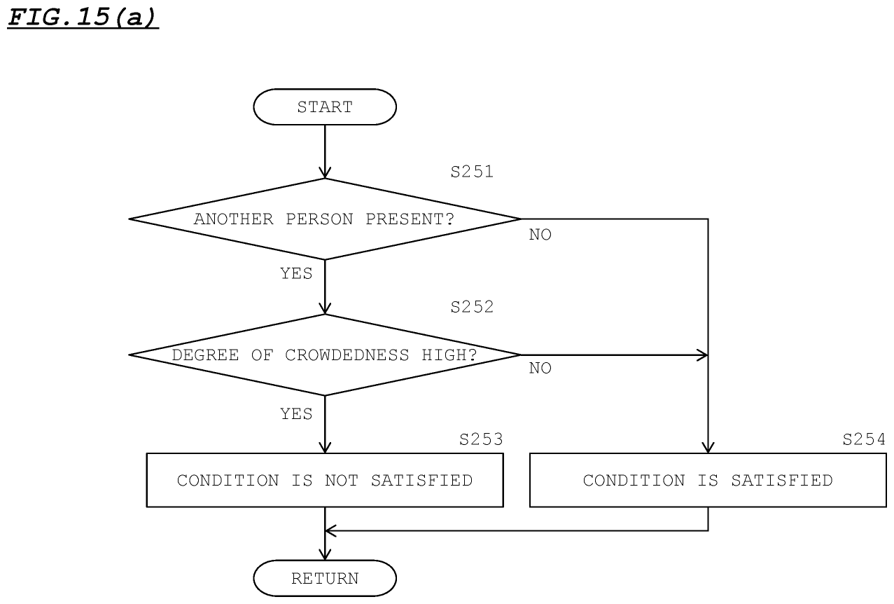

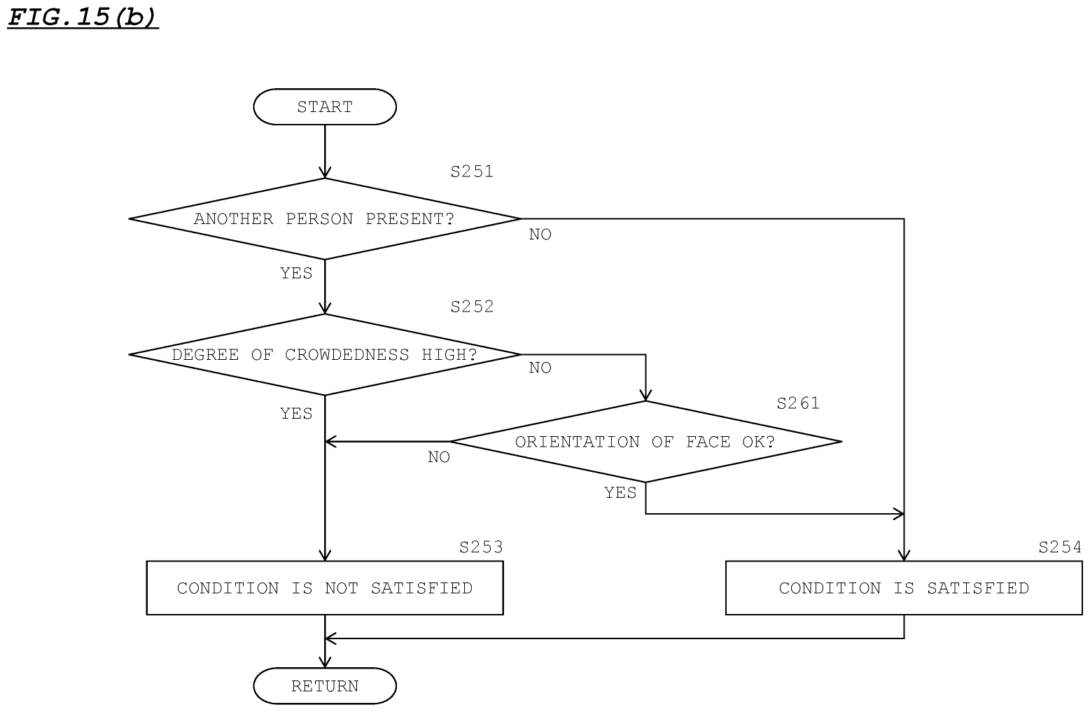

FIG. 15(a) is a flowchart showing a determination process regarding a removal condition in step S107 in FIG. 14.

Here, the determination regarding the removal condition based on the surrounding environment is performed only with respect to a mask. With respect to a wearing object (wearing object that hinders the age determination), such as sunglasses, other than a mask, the removal condition is determined to be satisfied, without performing a special process.

When the determination result in step S106 indicates that another person is not present around the commodity purchaser (S251: NO), the controller 111 determines that the removal condition is satisfied (S254). On the other hand, when another person is present around the commodity purchaser (S251: YES), the controller 111 determines whether or not the degree of crowdedness of other persons around the commodity purchaser is higher than a predetermined level, based on the determination result in step S106 (S252). Specifically, the controller 111 determines whether or not the number (crowdedness) of other persons exceeds a predetermined threshold, and further, determines whether or not the distance between the commodity purchaser and each of the other persons is shorter than a predetermined threshold.

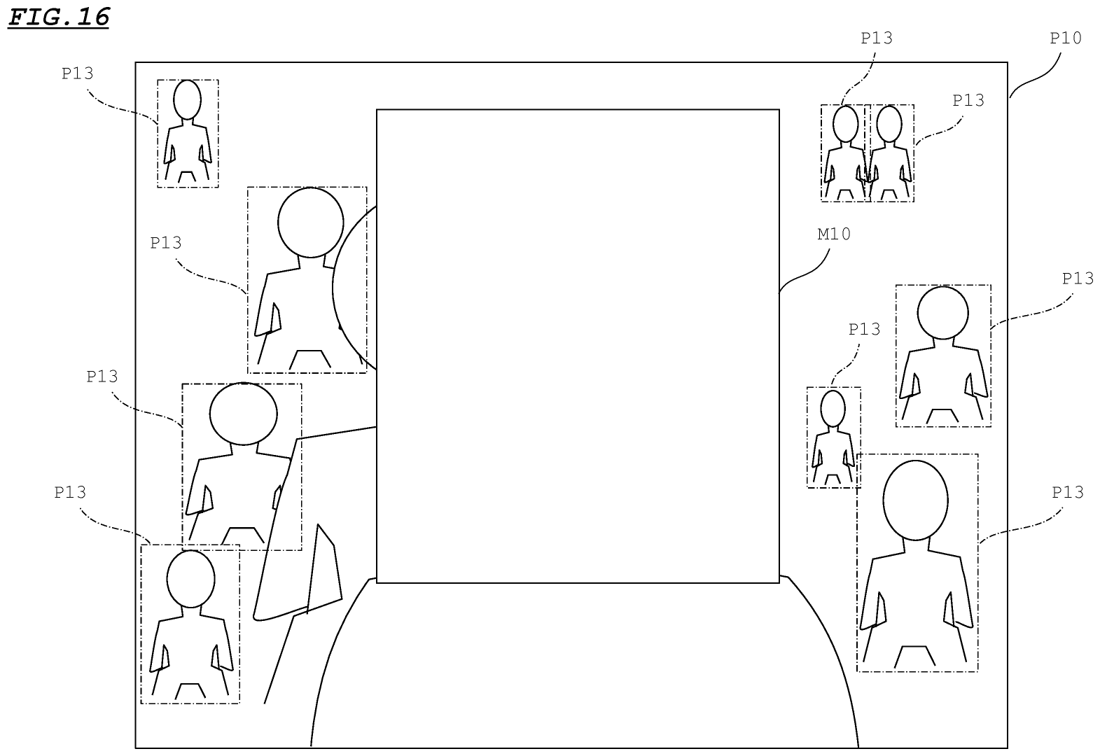

FIG. 16 shows a detection example of the degree of crowdedness. In this case as well, similar to the cases in FIG. 7 and FIG. 8, the controller 111 sets a region other than the mask region M10 in the region of the captured image P10, as an acquired region of the surrounding environment. Then, the controller 111 extracts, by the face recognition engine 112a, face images of other persons P13 present in the set acquired region of the surrounding environment, and further acquires, based on the sizes of the extracted face images, the distance to another person P13 in each face image.

Based on the distance and the face image of each of the other persons acquired in this manner, the controller 111 performs determination in step S252 in FIG. 15(a). Specifically, when at least one of: that the number of other persons extracted from the acquired region of the surrounding environment exceeds the predetermined threshold; and that the distance to each of these other persons is shorter than the predetermined threshold, has been satisfied, the controller 111 determines that the degree of crowdedness is high, and sets the determination in step S252 to YES.

When having determined that the degree of crowdedness of other persons is not high (S252: NO), the controller 111 determines that the removal condition is satisfied (S254). On the other hand, when having determined that the degree of crowdedness of other persons is high (S252: YES), the controller 111 determines that the removal condition is not satisfied (S253).

As for the determination process regarding the removal condition, as in FIG. 15(b), the orientation of the face of another person may further be taken into consideration. That is, even when the controller 111 has determined that the degree of crowdedness of other persons is not high (S252: NO), if the face of any of other persons present near the commodity purchaser is oriented toward the commodity purchaser (S261: NO), the controller 111 may determine that the removal condition is not satisfied (S253), and if the face of none of other persons present near the commodity purchaser is oriented toward the commodity purchaser (S261: YES), the controller 111 may determine that the removal condition is satisfied (S254).

With reference back to FIG. 14, when the removal condition is not satisfied with respect to at least one of the wearing objects (S107: NO), the controller 111 executes another age confirmation process (S144). The process in step S144 is similar to the above. On the other hand, when the removal condition has been satisfied with respect to all the wearing objects (S107: YES), the controller 111 performs output of removal guidance information for urging removal of the wearing object from the face (S108). In step S108, similar to Embodiments 1, 2 above, output of the removal guidance information is performed using the microphone 114, etc.

Through this guidance, when the target face image of the commodity purchaser no longer includes the wearing object that hinders the age confirmation (S105: NO), the controller 101 determines the age of the commodity purchaser, based on the target face image, by the age determination algorithm (S141), similar to the above. The processes in step S141 and thereafter are similar to the above. Then, in step S143 or step S144, the controller 111 transmits, to the higher-order device, a notification indicating that the age confirmation has been appropriate. Then, the controller 111 ends the process in FIG. 14.

### Effects of Embodiment 3

Similar to Embodiments 1, 2 above, according to Embodiment 3, when the presence or absence of a wearing object in the face image of the target person (commodity purchaser) has been detected (S105), removal of the wearing object is guided (S108) based on the determination result regarding the surrounding environment of the target person (S106). Therefore, while the captured image is used, removal of the wearing object can be more appropriately guided.

As shown in FIG. 15(a), based on the reference information, the controller 111 determines the degree of crowdedness of other persons present around the target person (commodity purchaser) (S252), and urges removal of the wearing object (mask). Accordingly, while the possibility of causing contract of a disease to another person due to mask removal can be more assuredly avoided, age confirmation of the target person (commodity purchaser) can be performed.

In the process in FIG. 15(b), the controller 111 urges removal of the wearing object (mask), based on (S261) the orientation of the face of another person. Accordingly, at age confirmation, the possibility of causing contract of a disease to another person due to mask removal can be even more assuredly avoided.

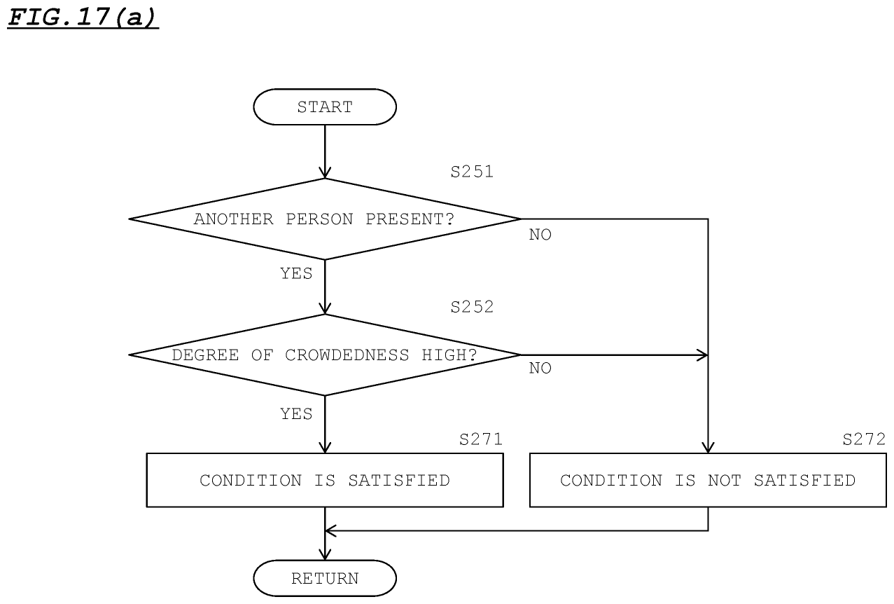

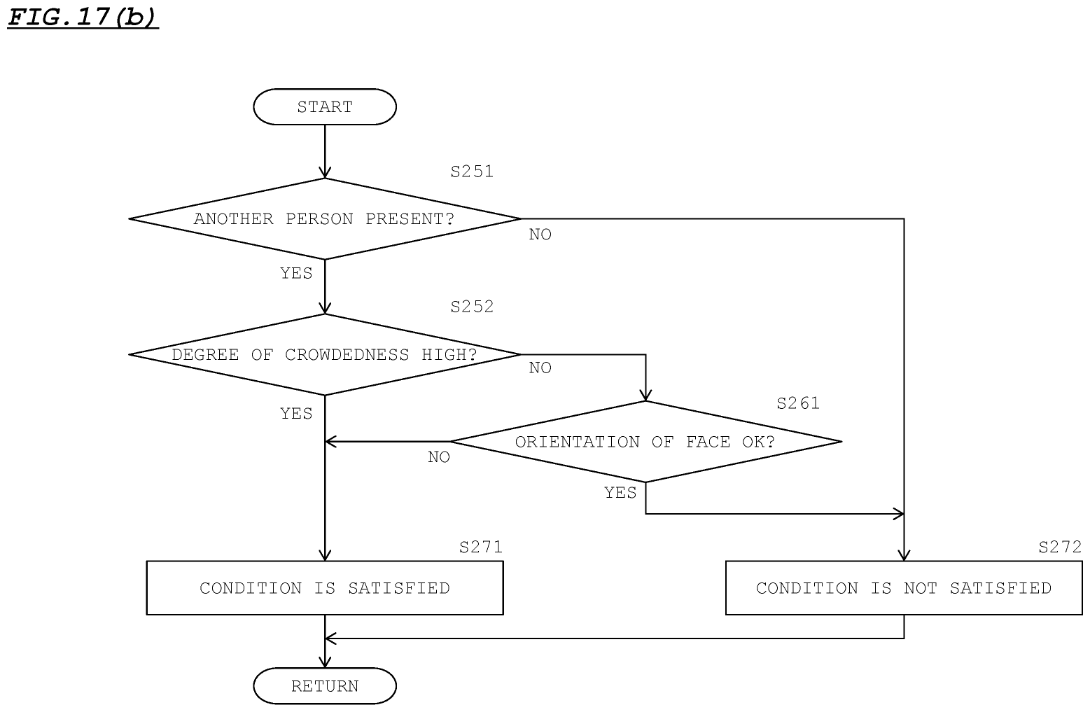

In Embodiment 3 as well, the controller 111 may urge wearing of a mask with respect to the commodity purchaser, through a process similar to that in FIG. 10. In this case, the process in step S123 in FIG. 10 is changed to a determination process regarding a wearing condition shown in FIG. 17(a) or FIG. 17(b). Here, step S254, S253 in FIGS. 15(a), 15(b) are replaced with steps S271, S272. The processes of the other steps in FIGS. 17(a), 17(b) are similar to those of corresponding steps in FIGS. 15(a), 15(b).

In step S271, when the degree of crowdedness of other persons is high or when the face of another person is oriented toward the target person (commodity purchaser), a wearing condition for a mask is determined to be satisfied. In step S272, when the degree of crowdedness of other persons is not high or when the face of another person is not oriented toward the target person (commodity purchaser), the wearing condition for a mask is determined not to be satisfied.

Through this wearing guidance process, to a commodity purchaser not wearing a mask at age confirmation, wearing of a mask can be appropriately urged after the age confirmation. Therefore, contracting a disease due to non-wearing of a mask in a store can be even more assuredly prevented.

The determination of the degree of crowdedness in FIGS. 15(a), 15(b) and FIGS. 17(a), 17(b) may be performed using only either one of a captured image and sound. However, the determination of the distance between the commodity purchaser and another person and the determination of the orientation of the face of another person are difficult to be made based on sound, and thus, are preferably performed using at least a captured image. In a case where steps S252, S261 are omitted from the processes in FIGS. 15(a), 15(b) and another person is present in the surroundings, it may be uniformly determined that the removal condition is not satisfied. This also applies to the processes in FIGS. 17(a), 17(b).

The processes shown in FIGS. 15(a), 15(b) may be applied to step S107 in FIG. 3, in place of the process in FIG. 4(a) in Embodiment 1 above.

### Modification

In the embodiments above, the processes in FIG. 3, FIG. 10, FIG. 12, and FIG. 14 are performed by one controller, but these processes may be apportioned between and performed by a plurality of controllers.

For example, in the configuration in FIG. 13 shown in Embodiment 3 above, the processes in steps S106, S107 in FIG. 14 may be performed by a controller on the higher-order device side. In this case, when the determination result in step S105 in FIG. 14 is YES, the controller on the higher-order device side receives a notification indicating this from the controller 111 of the dialogue device 110 in FIG. 13. Then, for example, based on sound information and a captured image acquired from a monitoring camera, the controller on the higher-order device side executes the processes in steps S106, S107 in FIG. 14, and transmits the determination result to the dialogue device 110. Based on the determination result received from the controller on the higher-order device side, the controller 111 of the dialogue device 110 executes the process in step S108 or the process in step S144 in FIG. 14. That is, when the received determination result indicates that the condition has been satisfied, the controller 111 executes the process in step S108, and when the received determination result indicates that the condition has not been satisfied, the controller 111 executes the process in step S144.

In this case, a purchase permission system composed of a higher-order terminal and the dialogue device 110 shown in FIG. 13 corresponds to a dialogue device described in the claims. With this, effects similar to those in Embodiment 3 above can also be exhibited. In Embodiment 2 as well, a part of the control may be apportioned to the controller on the vehicle side.

Also in a case where a plurality of terminal devices are connected to a central control device by a local area network (LAN), the guidance control using a face image for removal or wearing of a wearing object may be apportioned between and performed by the terminal devices and the central control device. In this configuration, all of the guidance controls using a face image for removal or wearing of a wearing object may be performed by each terminal device, or may be performed by the central control device. In the latter case, necessary information may be transmitted/received as appropriate between the terminal device and the central control device via the LAN.

The configuration of the dialogue device is not limited to the configurations described in Embodiments 1 to 3 above, and can be changed as appropriate. For example, the camera, the microphone, and the speaker may be disposed on the dialogue device, or those provided in advance in a system in which the dialogue device is mounted may be used. The dialogue device need not necessarily include a display or a touch panel, and these may be omitted when a dialogue is performed only in sound.

The target to which the present invention is applied is not limited to the device or system shown in the embodiments above, and may be various other devices and systems.

For example, the configuration and process for age confirmation shown in Embodiment 3 may be applied to another vending machine or the like for commodities with age restriction. The configuration of the wearing guidance process or the facial expression determination process described above may be provided to a customer reception robot or a customer-guiding robot provided at a large store or the like, and these robots may form a dialogue device. A dialogue device including the configuration of the wearing guidance process described above may be disposed at an entrance of a facility such as a hospital or a boarding gate of a passenger plane or the like. Other than this, the present invention can be widely applied to a device or a system that includes processes, such as the identity authentication process, the wearing guidance process, the facial expression determination process, and the age confirmation process, of urging removal or wearing of a wearing object with respect to a face, based on a face image included in a captured image.

Various modifications can be made as appropriate to the embodiments of the present invention, without departing from the scope of the technological idea defined by the claims.

### DESCRIPTION OF THE REFERENCE CHARACTERS

10 vehicle
100, 110 dialogue device
101, 111 controller
102, 112 storage
101a clock circuit
102a, 112a face recognition engine
102b, 112n wearing object recognition engine

1. A dialogue device configured to perform a predetermined dialogue, based on a face image included in a captured image, the dialogue device comprising:
a controller configured to perform a control for the dialogue, wherein
the controller
specifies a face image of a target person from the captured image,
detects presence or absence of a wearing object with respect to a face of the target person from the face image having been specified,
determines a surrounding environment of the target person, based on predetermined reference information, and
causes an output part to output information that urges removal or wearing of the wearing object, based on the surrounding environment.

2. The dialogue device according to claim 1, wherein
the reference information includes the captured image, and
the controller determines, as the surrounding environment, a situation of another person other than the target person included in the captured image, and urges removal or wearing of the wearing object.

3. The dialogue device according to claim 2, wherein
the controller urges removal or wearing of the wearing object, based on orientation of a face of the other person.

4. The dialogue device according to claim 1, wherein
the reference information includes sound around the target person, and
the controller determines, as the surrounding environment, a situation of a person other than the target person from the sound, and urges removal or wearing of the wearing object.

5. The dialogue device according to claim 1, wherein
the controller determines a degree of crowdedness of other persons present around the target person, based on the reference information, and urges removal or wearing of the wearing object.

6. The dialogue device according to claim 1, wherein
the wearing object is a mask.

7. The dialogue device according to claim 1, wherein
the wearing object is sunglasses,
the reference information includes a current time, and
the controller determines, based on the current time, whether or not sunlight is in a situation of being able to be incident on the face of the target person, as the surrounding environment, and urges removal or wearing of the sunglasses.

8. A dialogue method for automatically performing a predetermined dialogue, based on a face image included in a captured image, the dialogue method comprising:
specifying a face image of a target person from the captured image;
detecting presence or absence of a wearing object with respect to a face of the target person from the face image having been specified;
determining a surrounding environment of the target person, based on predetermined reference information; and
outputting information that urges removal or wearing of the wearing object, based on the surrounding environment.
